(19) United States
(12) Patent Application Publication
(10) Pub. No.: US 2013/0033861 A1
(43) Pub. Date: Feb. 7, 2013

(54) Retrofit LED light Panel

(71) Applicant: Kevin Orton, (US)

(72) Inventor: Kevin Orton, (US)

(21) Appl. No.: 13/564,701

(22) Filed: Aug. 1, 2012

Related U.S. Application Data
(60) Provisional application No. 61/513,988, filed on Aug. 1, 2011.

(51) Int. Cl. F21V 9/00; F21V 21/00

(52) U.S. Cl. 362/231; 362/249.02

(57) ABSTRACT

An LED retrofit and kit for existing fluorescent light fixtures. The kit provides a quick and easy way to upgrade existing fluorescent lights to LED lights.

This application claims priority to U.S. application 61513988, filed 1, AUG 2011.

### BACKGROUND OF THE INVENTION

Fluorescent lights are common and popular because they save energy. Many such fluorescent lights come in fixtures that mount and hold the bulbs in place. Many of the fixtures are pre-fabricated with the ballast which is usually required to operate the fluorescent light bulb. There are many fluorescent light fixtures installed presently.

But new types of lights such as light emitting diodes (LED's) are also desirable to use. LED's provide numerous advantages over fluorescent bulbs, such a much longer life.

When converting existing lights from fluorescent bulbs to LED bulbs, it is desirable to do so as easily and quickly and economically as possible. For that reason it is desirable to provide means to convert fluorescent light fixtures to LED type fixtures with minimum effort and cost. However, fluorescent light fixtures are often permanently or semi-permanently installed, which makes removal or replacement difficult.

Various prior art devices include means to remove the ballast and fluorescent tubes from the light fixture, and replace the ballast and bulbs with LED types. But installing new LED bulbs into such fixtures can also be difficult, as it is a lot of work to remove the old parts before installing the new ones. Also, the prior art continues to use the existing lens piece on the front of the light assembly. Such typical lens pieces are often optimized for fluorescent bulbs, and may not provide optimal performance, as far as light distribution pattern and other factors, when LED bulbs are fitted. Thus easier retrofit means are desired. This invention provides such a means.

### BRIEF DESCRIPTION OF THE DRAWINGS

FIG. 1 is a general view of a typical existing fluorescent light fixture with a removable front mounted lens.

FIG. 2 is a cross sectional side view of the replacement lens with the integrated Led's as provided by the present invention.

FIG. 3 is a back side view (interior) view of the replacement lens.

FIG. 4 is a front side (exterior) view of the replacement lens mounted in an existing lens holder/troffer or other fixture.

FIG. 5 is an alternate embodiment of the invention, using LED's arranged in a strip configuration.

FIG. 6 is an illustration of light wavelengths in one aspect of the invention.

### DETAILED DESCRIPTION OF THE DRAWINGS

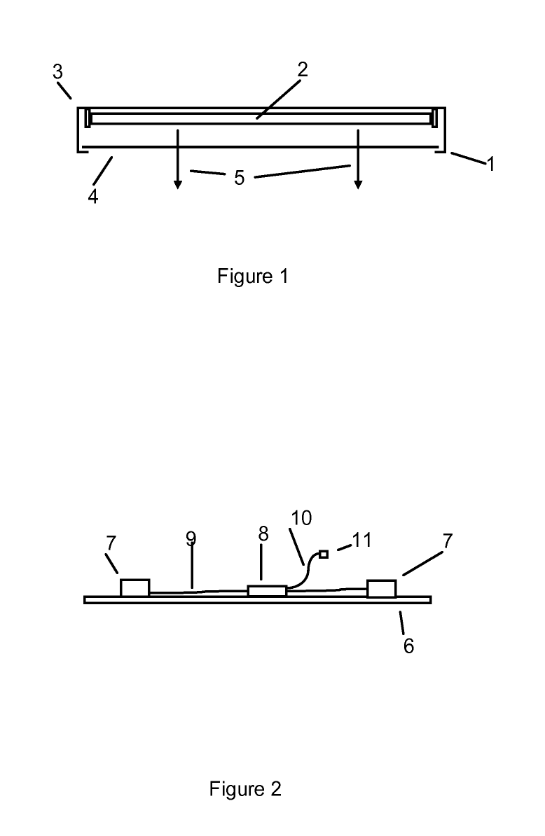

FIG. 1 shows a cross section of a typical existing fluorescent light fixture. There is a frame (1), one or more bulbs (2,) bulb socket connectors (3), and a lens (4). Light (5) from the fixture travels from the bulb (2), and out through the lens (4). The housing frame (1) may also serve to act as a means to support the lens (4). Common lens sizes used are 2 feet (610 mm) by 2 feet (610 mm) , and 2 feet (610 mm), by 4 feet (1220 mm) (give or take manufacturing tolerances), but other sizes are found as well.

FIG. 2 is a cross sectional view of the present invention. In the preferred embodiment, it includes a base unit comprising a front panel (6), one or more LED light assemblies (7), various other circuitry as needed such as voltage reducers or the like (8), interconnect wiring as needed (9), a feed wire (10), and a connector or junction box or plug as desired (11). In the present invention, the panel (6) is also sized and fitted so as to match a lens (4) of FIG. 1

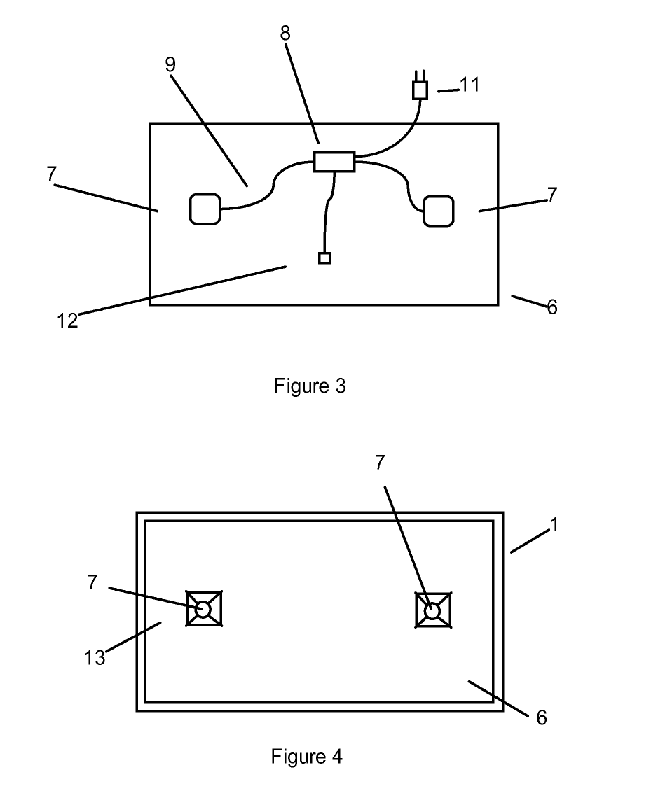

FIG. 3 shows the back side of panel (6), including LED lights (7), voltage converter (8), wiring (9) connector plug (11). Other optional equipment may also be mounted on the panel, such as an occupancy sensor (12). The occupancy sensor is wired in to the voltage converter (8) or other circuitry and functions as a motion detector so as to turn the LED lights (7) on or off depending if there are people in the room. The occupancy sensor may include dials and other controls to adjust sensitivity and duration and other factors.

FIG. 4 shows the front side of the front panel. The panel (6) sits in the frame (1) of an existing fixture when installed, previously used by the lens in FIG. 1, (4). The panel (FIG. 4) holds the LED's 7, which shine outward from the panel. Various reflectors and lenses may be included for the LED's (13). In the preferred embodiment, the retrofit panel allows the LED light to exit, but is opaque to the previous light fitting(s) in the housing behind it.

Some existing fixtures have swing covers to allow access to the bulb area. In such designs, the plastic lens lifts out of the fixture when the swing cover is opened, allowing the present LED light panel to be fitted.

Other existing fixtures have fixed support frames FIG. 1, (1) attached to the ceiling and no swing cover. Such designs have flexible plastic lenses (4) that must be bent slightly and lifted out of the frame opening (1) to gain access to the bulb area (2) for replacement. In one advantageous embodiment of the present invention, the panel (6) is made of a flexible material. The flexible material is similar in flexibility to the plastic lens piece (4) it replaces, and so allows the present panel to be bent and slipped into and fitted to existing frames (1) that require bending of the panel to place the lens, without modification of the existing frame (1).

The panel provides a simple and easy way to retrofit the existing fluorescent light fixture without the need to even remove the old bulbs and parts. It also provides potentially improved lenses for the LED bulbs, as mounting the LED's behind the existing fluorescent lens in the prior art often may not give proper and optimal lens design and function when using an LED light source. The optional integrated occupancy sensor on the panel provides optimum sensor location, and does not need to shine through the prior fluorescent lens, which would interfere with the occupancy sensing. It also greatly simplifies retrofit applications which can otherwise be cumbersome and difficult to wire and install and locate a suitable location for the sensor.

The occupancy sensor may be of the known infrared, microwave, or other type. The panel made be made of any sort suitable of material, including wood, metal, plastic and so on, and may have various decorative finishes. A metal backing may be included for safety grounding.

FIG. 5 shows an alternate embodiment using strip lights. There is a panel 6. When installed, the panel sits in a frame 1. Numerous smaller LED's 8 are spread out in one or more strips 9 or other distributed arrangement. In this embodiment, the led's are spread out more over the surface of the panel. This can help give a more uniform light pattern, and help spread heat out more evenly.

LED's lights typically have a limited spectral wavelength, and may be manufactured in several various wavelengths to cover the visible spectrum. For example, 3500 degrees K and 5000 degrees K. These various light emission wavelengths have different appearances to the user, such as “warm white” and “cool white”. The color of the LED is determined by the semiconductor used, and the phosphor coating used on it.

It is difficult to make an LED that is both efficient and with a single phosphor that effectively covers the visible light spectrum. That has been found to cause viewing difficulties over a period of time, particularly when only a narrow spectrum of light of observed, and no outside light is available to supplement it. A sort of tunnel-vision effect occurs after several weeks and months where viewing becomes very dim. Seemingly as if from using some of the rods and cones, but not others, resulting in a relative overload and blockage of the used rods and cones unless and until the other received some stimulation from outdoor or broad wavelength light.

Advantageous results were found by using several different wavelength LED lights in the same panel, each with different color output curves, so as to provide an overall broader light spectrum, without the limitations of any single phosphor. Using multiple LED lights of mixed wavelengths in the panel was found to advantageously reduce viewing fatigue over long periods of time. (days and weeks and months) by seemingly allowing more eye rods and cones to be sensitized to match that occurring by normal light. This also prevents the brain and eyes from having to re-adjust as much when going from outside to inside. The “Strip” LED of FIG. 5 is particularly well adapted to accommodate multiple wavelength LEDs in a single panel with no visible color shifts of the various LED's. In such an embodiment, LEDs of mixed wavelength may for example be alternated back and forth along the strip, with for example the first LED (8) one color, the next LED 10 another wavelength, and each successive LED an alternating color. Generally, both (or all) wavelengths illuminate concurrently. This provides a seamless and easier viewing effect for the user, with less viewing adjustment required and no long term fatigue.

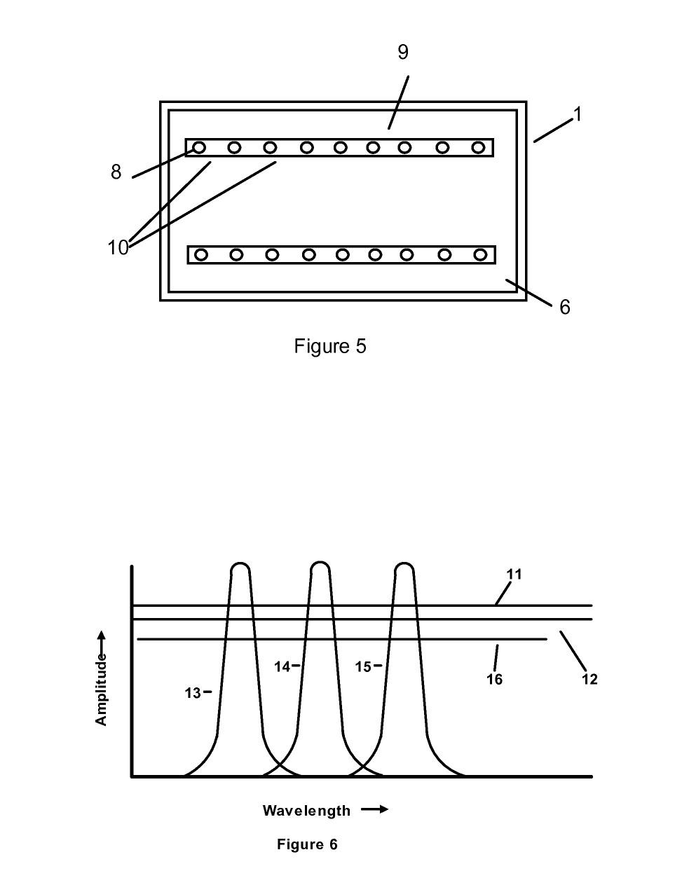

This effect is shown in FIG. 6. FIG. 6 is a chart of relative light amplitude versus wavelength. The human eye is more or less even sensitivity 11 across the visible spectrum. Resistive (tungsten) lighting and solar lighting uses random (Brownian) electron motion to generate photons, and so generally gives off more or less even light amplitude across the spectrum 12. Phosphor lighting 13 uses resonance tuning to emit photons, and is thus limited in a more narrow peaking range. Other phosphors 14 and 15 give off different wavelengths at their peak. No one single phosphor covers well all light wavelengths with good efficiency. By using multiple LED's in the fixture, each at a different wavelength, their combined light output 16 more closely resembles the evenly spectral distribution of Brownian lighting, while retaining good resonance efficiency. Although each Led radiates at a different color, the overall light is effectively mixed in the air before reaching the viewer's eyes. In the preferred embodiment, the combination of cool and warm and other LED's is arranged so as to provide a neither “cool” nor “warm” light output, but an even spectrum across the viewing color range, and preferably matching the spectrum of resistive lighting, and more preferably solar lighting or broad spectrum white lighting. This is achieved by mixing phosphors and semiconductors such that primary resonant frequencies occurs in at least two, and preferably three of more different wavelengths across the visible spectrum.

In the present invention, the existing fluorescent ballast and tube holders (or even tubes themselves) need not be removed at all. Though they of course can be removed if desired.

In the present invention the word “lens” is meant to include various lenses, diffusers, louvers, grills, filters, and other such devices that are conventionally placed between the fluorescent bulb and the lighted area. LED is meant to include various light source devices, including light emitting diodes, electroluminescent strips, and other light output devices.

Thus this invention provides an easy and effective means to convert an existing fluorescent fixture to an LED fixture. It also provides and allows proper lens design and optimum lens filtering effect for the LED bulb, is much easier to install and also provides other operational advantages over the prior art.

### REFERENCES

| | | Patent | | | |
|---|---|---|---|---|---|
| Title | Date | Number | Inventor | App Number | Filing Date |
| Fluorescent | Oct. 20, | 5,823,663 | Bell, et | 08/731,826 | Oct. 21, |
| troffer | 1998 | | al. | | 1996 |
| lighting | | | | | |
| fixture | | | | | |
| Ceiling- | Mar. 30, | 7,686,484 | Heiking, | 12/023,826 | Jan. 31, |
| mounted | 2010 | | et al. | | 2008 |
| troffer-type | | | | | |
| light fixture | | | | | |
| LED retrofit | May 25, | 6,739,734 | Hulgan | 10/389,004 | Mar. 17, |
| method and | 2004 | | | | 2003 |
| kit for | | | | | |
| converting | | | | | |
| fluorescent | | | | | |
| luminaries | | | | | |

1) A panel, including one or more LED lights affixed thereto, sized and arranged to replace an existing fluorescent light fixture lens.

2) A panel, including one or more LED lights affixed thereto, sized and arranged to replace an existing fluorescent light fixture lens, which includes an occupancy sensor.

3) An LED light fixture containing multiple LED's, each emitting light at a different wavelength for even color rendition.
